(19) United States
(12) Patent Application Publication
(10) Pub. No.: US 2024/0415617 A1
(43) Pub. Date: Dec. 19, 2024

(54) EZ Tooth

(71) Applicant: Robert Gist, Amarillo, TX (US)

(72) Inventor: Robert Gist, Amarillo, TX (US)

(21) Appl. No.: 18/209,428

(22) Filed: Jun. 13, 2023

(51) Int. Cl. A61C 13/107; A61C 13/225

(52) U.S. Cl. CPC A61C 13/0001; A61C 13/225

(57) ABSTRACT

The present invention is a method that is integral for cosmetically filling in areas of missing teeth. In particular, the embodiment allows a person to utilize pre-formed temporary tooth material to easily insert with their finger. The proposed embodiment provides a unique experience for users by providing a convenient experience for the general public.

### CROSS-REFERENCE TO RELATED APPLICATIONS

None.

### BACKGROUND OF THE INVENTION

### Field of the Art

The invention relates generally to the field of dentistry, and more particularly to the field of dental cosmetics. The disclosure further relates to a convenient method for replacing a missing tooth with a temporary tooth by utilizing pre-formed material and orally applying the temporary tooth in a novel manner to a space where a naturally grown tooth is missing. It is worth noting that the disclosed preformed material referenced herein can be designed in a variety of sizes and shapes but preferably it will be shaped as a tooth.

### Discussion of the State of the Art

Human teeth serve a variety of functions. Not only are they important for chewing food, but they can also be necessary for confidence. Healthy and well aligned teeth are an ideal of beauty and appear as a cosmetic sign of youth and success. Although various preventive measures, like frequent tooth brushing and flossing, and drinking fluoridized water are widely accepted and used, the great majority of people are sooner or later challenged with dental fillings, restoration implants, and prosthesis. Traditionally, a person in need of a temporary tooth or similar services had to pay a significant amount of money to have pre-dental services performed. The traditional methods involved complex procedures which can be very costly and painful. Dentists can often use partial dentures which are secured in your mouth with metal clasps that attach to the adjacent teeth. Furthermore, in previous applications users often would have to utilize temporary bridges which are similar to a partial implant where the dentist would use a nearby tooth to anchor the bridge to fill a gap. Additionally previous approaches involved consumers attempting to manually shape beaded material into a naturally looking tooth which has proven to be difficult for most consumers. This approach was particularly difficult because consumers lacked either the skill or training to shape material into a “teardrop shape” to replicate a natural looking tooth. Utilizing previous methods of performing such dental procedures were costly, painful, and not very convenient. Accordingly, what is needed in the art is a novel manner of applying a temporary tooth for cosmetic purposes. What is further needed in the art is a novel manner for users to utilize temporary teeth for unsightly gaps. The proposed embodiment is further ideal because its ultimate purpose is to help users apply temporary teeth in a convenient manner without the need for a dental visit. The product is a pre-formed “teardrop” shaped temporary tooth that eliminates the need for a user to manually shape a tooth which can be a difficult process for consumers. The inventive concept only requires that a user drop a pre-shaped temporary tooth into water, heat it then insert into the gap, fold the excess to the rear for tension, then remove to let fully cure, then reinsert the cured temporary tooth.

The public is eager to welcome such a convenient method for improving their dental appearance.

### SUMMARY OF THE INVENTION

In view of the foregoing, various embodiments of the present invention beneficially provide customized pre-formed temporary teeth based on a process.

Accordingly, the inventor has conceived, in a preferred embodiment a method and material for a user to apply a temporary tooth.

According to a preferred embodiment of the invention, is a method that allows a user to apply a pre-formed temporary tooth to a space in their mouth where a natural tooth is missing. What is further disclosed is a method that allows the user to choose from a plurality of molded material that is shaped in an appealing manner prior to oral application. The ability of the method to be utilized by users in a manner that saves time and expenses will be welcomed among users.

### BRIEF DESCRIPTION OF THE DRAWING FIGURES

The accompanying drawings illustrate several methods of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a perspective view of a pre-formed temporary tooth placed in heated water, according to a preferred embodiment of the invention.

FIG. 2 is a view of the pre-formed temporary tooth being prepared for insertion into a user's mouth, according to a preferred embodiment of the invention.

FIG. 3 is a view of a temporary tooth being placed in a gap where a natural tooth is missing, according to a preferred embodiment of the invention.

FIG. 4 is a perspective-view of a user's finger being used to re-insert the temporary tooth after proper curing, according to a preferred embodiment of the invention.

### DETAILED DESCRIPTION

The inventor has conceived, a process and method for utilizing pre-formed temporary teeth to help replace unsightly missing teeth.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Materials described or referenced herein will sometimes be described in singular form for clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

Headings of sections provided in this patent application and the title of this patent application are for convenience only and are not to be taken as limiting the disclosure in any way. A description of an embodiment with several components in connection with each other does not imply that all such components are required.

The embodiment is directed generally to a method for utilizing a temporary tooth, and in particular to apply pre-formed material for replacing a missing tooth.

Additionally, in a non-limiting example the embodiment comprising material made out of a combination of suitable material known in the art.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. Various structures and/or features are not necessarily drawn to scale. In other instances, structures and features are shown in two-dimensional diagram form in order to facilitate describing the claimed subject matter. As provided herein,

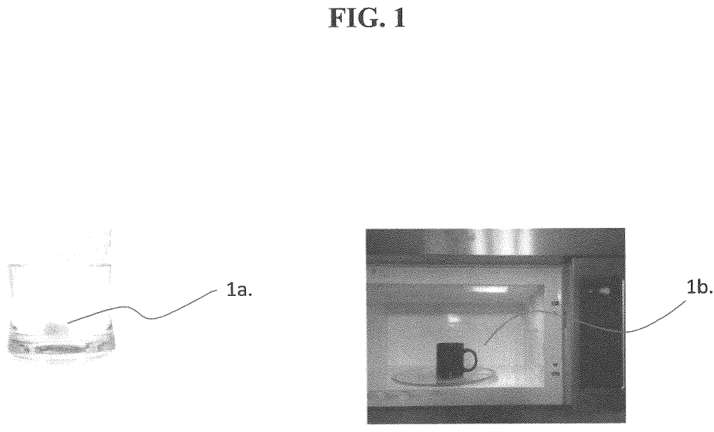

With reference to the attached figures, as illustrated in FIG. 1, a view of a soft low temp polymer plastic preformed temporary tooth placed into water 1a. and heating the water to a predetermined temperature 1b. prior to applying the temporary tooth in the user's mouth. This step is critical because it allows the manufactured pre-formed tooth to become pliable in order to flexibly apply the temporary tooth in a user's mouth.

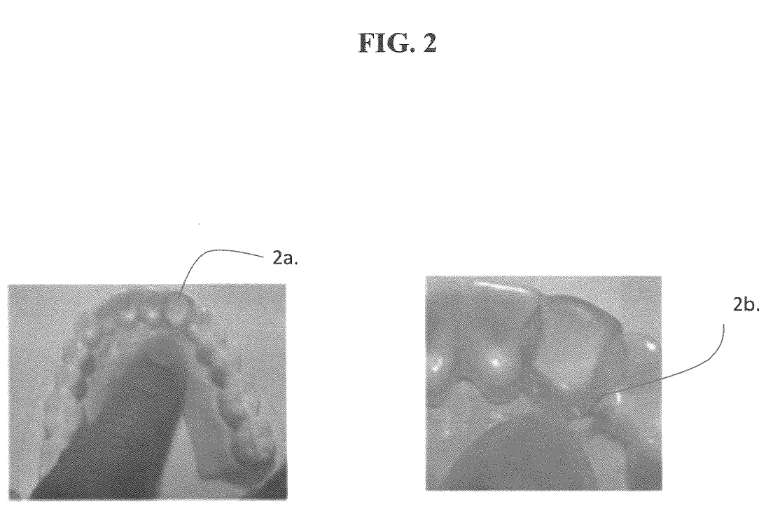

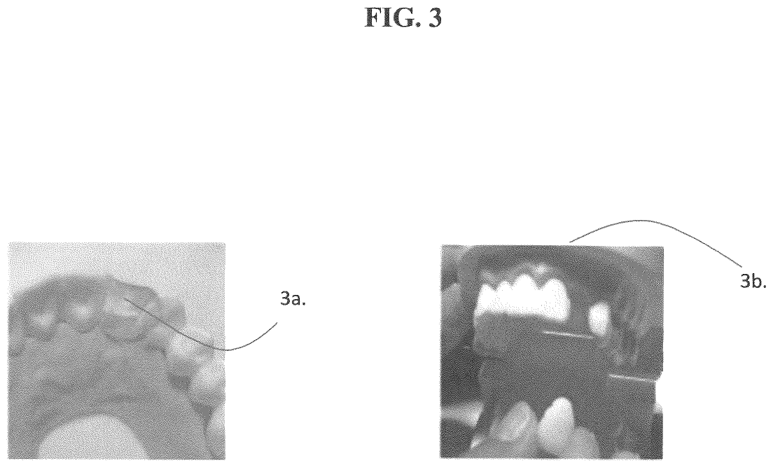

The embodiment as illustrated in FIG. 2., a perspective view of the pre-formed tooth being applied to a gap in a user's mouth 2a. The depiction shows how a user would use their finger to simply fold at the bottom of the temporary tooth and push the extra material to the back 2b., and to the sides of the teeth beside the missing tooth. Like small supports, this is what holds the temporary “tear shaped” tooth in place. Accordingly, to this configuration a user is able to prepare the temporary tooth prior to the material becoming cured. Further, as shown in FIG. 3, a perspective view of the state of the temporary tooth once it becomes firm 3a. but before it looks completely white (almost a gray color) remove the tooth 3b. and let it fully cure in place, preferably 10-15 minutes. If the user has trouble removing the temporary tooth, then the user can simply swish a warm fluid around in their mouth such as warm water to make sure the tooth becomes softened which will enable it to be easily removed.

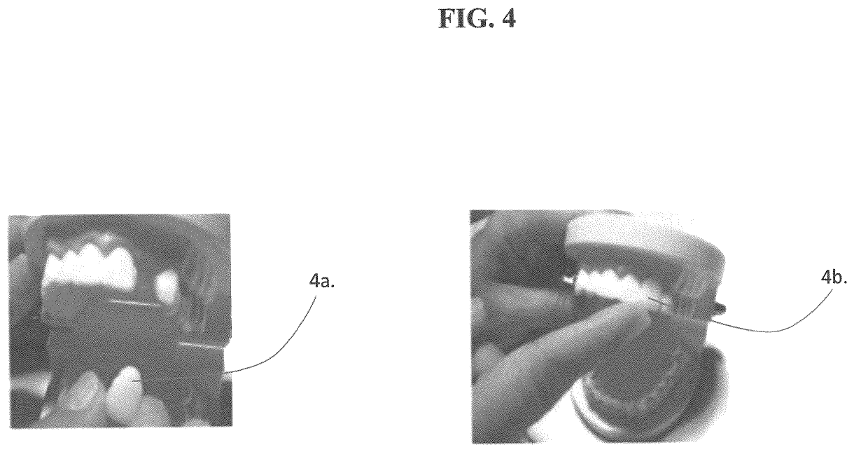

Further, as shown in FIG. 4, is a depiction of the temporary tooth being re-inserted back into a user's mouth 4a. after allowing the tooth to fully cure out of the mouth, and after it has become fully white in color. The user can snap the temporary tooth back in the gap where the natural tooth is missing 4b. Furthermore, the user can trim any excess from the back surface of the tooth using a suitable instrument.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

The skilled person will be aware of a range of possible modifications of the various embodiments described above. Accordingly, the present invention is defined by the claims and their equivalents.

What is claimed is:

1. A process for applying a pre-formed temporary tooth in a user's mouth where a natural tooth is missing; comprising the steps of:
implementing an exclusively non-invasive, non-surgical procedure that includes,
(a) obtaining a manufactured pre-formed tear drop shaped temporary tooth, prior to firming condition;
(b) heating water to a predetermined temperature and placing the pre-formed tooth into the heated water;
(b) removing the pre-formed tooth from the water and placing the pre-formed tooth into a missing tooth gap;
(c) pushing the pre-formed tooth slightly;
(d) using a finger, fold at the bottom and push an extra amount of material to the back and sides of the temporary tooth;
(e) once the temporary tooth becomes firm but before it looks completely white remove the temporary tooth and let it finish curing out of the user's mouth;
(f) if it is difficult to remove the temporary tooth, the user will swish a warm fluid around in the user's mouth to make the temporary tooth softer and easier to remove;
(g) after allowing the temporary tooth to fully cure out of the user's mouth, snap the temporary tooth back in place; and
(h) trim any excess from the back side of the temporary tooth using a suitable instrument.

2. The method of claim 1, wherein the temporary tooth further is allowed to cure for a predetermined amount of time after the tooth becomes firm in step (e).

3. The method of claim 1, wherein each subsequent application of the temporary tooth requires that the user repeat steps (a)-(h) to ensure a proper fit.

4. The method of claim 1, wherein the pre-formed temporary tooth comprises any suitable pre-manufactured material known in the art.

5. The method of claim 2, wherein the temporary tooth is further comprised of a soft low temp polymer plastic.
